(19) United States
(12) Patent Application Publication
(10) Pub. No.: US 2014/0183047 A1
(43) Pub. Date: Jul. 3, 2014

(54) Regeneration System for Metal Electrodes

(71) Applicants: Iakov Kogan, Etobicoke (CA); Anna Khomenko, Etobicoke (CA)

(72) Inventors: Iakov Kogan, Etobicoke (CA); Anna Khomenko, Etobicoke (CA)

(73) Assignee: PANISOLAR INC., Mississauaga (CA)

(21) Appl. No.: 13/732,406

(22) Filed: Jan. 1, 2013

(51) Int. Cl. H01M 4/02

(52) U.S. Cl. CPC H01M 4/02
USPC 205/59; 204/242; 204/252; 205/64; 205/66; 205/57

(57) ABSTRACT

The electrochemical regeneration of a replaceable metal electrode of a metal-air battery takes place in a supplementary electrochemical cell with a chemical agent oxidized on the counter electrode. The decrease of the regeneration voltage at the supplementary electrochemical cell results in the growth of the regeneration efficiency. The creation of a commercial product during chemical agent oxidation on the counter electrode decreases the overall cost of the regeneration. Possible chemical agents for regeneration include salts, metal complexes, monomers, conjugated organic molecules, oligomers or polymers.

References cited:

| | | | | Name of patentee |
|---|---|---|---|---|
| # | Patent # | Code | Issue date | or applicant |
| 1 | U.S. Pat. No. 7,482,081 | B2 | 2009-01-29 | Zongxuan Hong |
| 2 | U.S. Pat. No. 5,569,555 | | 1996-10-29 | Jonathan Goldstein |
| | | | | et al |
| 3 | EP0,564,664 | A1 | 1993-10-13 | Jonathan Goldstein |
| | | | | et al |

### BACKGROUND OF THE INVENTION

1. Field of the Invention

The present invention relates to the areas of the energy storage and demand response management systems. Metal-air batteries of this invention are hybrid cells that include the air electrode of a fuel cell and a rechargeable metal electrode of the secondary battery, classes H01M 12/06, 429/9. Further, the invention belongs to the cells having a regenerating feature, classes H01M 10/42, 429/49. The rechargeable metal electrodes of this invention are selected from metal electrodes that can be recharged in aqueous, non-aqueous or molten salts electrolytes.

Words regeneration, recharge, recovery are used as equivalents for electrochemical reduction, and are interchangeable in this invention. A solvent with a dissolved electrolyte is often called aqueous or non-aqueous electrolyte. The recovery efficiency is defined as the ratio of the energy released during discharge to the energy required to charge the battery.

2. Description of the Prior Art

A recovery system described by Hong in U.S. Pat. No. 7,482,081 continuously regenerates the metal electrode of the battery in-situ as the electrode is consumed during discharge. As an example the inventors use sodium borohydride solution to continuously recover zinc electrode. The disadvantage of this invention is its complexity, and its occurrence inside the battery.

Goldstein et al in the U.S. Pat. No. 5,569,555 and EP No 0564664 offer a method of regeneration of the rechargeable zinc electrode by its disintegration, electrochemical reduction of the soluble and insoluble parts of the zinc electrode, and reconstruction of the zinc electrode by compression. The disadvantage of this process is its complexity and high cost.

### SUMMARY OF THE INVENTION

The regeneration of the replaceable metal electrode of the metal-air battery in the supplementary electrochemical cell proceeds simultaneously with the oxidation of a chemical agent other than water on the counter electrode. As the result, the energy losses associated with the overvoltage of water oxidation in the rechargeable metal-air battery are decreased, and the recovery efficiency is dramatically increased in comparison with the conventional rechargeable zinc-air battery. Besides, the generation of a commercial product simultaneously with metal electrode recovery leads to the decrease of the cost of the metal electrode regeneration.

### BRIEF DESCRIPTION OF THE DRAWINGS

FIG. 1A-FIG. 1C explain the process of the metal electrode recovery in the regeneration cell.

FIG. 1A shows the metal-air battery 3 with the metal electrode 1 before the transfer of the metal electrode 1 into the regeneration cell 4.

FIG. 1B shows the regeneration cell 4 before the transfer of the metal electrode 1 into said regeneration cell.

FIG. 1C shows the metal metal-air battery 3 after the transfer of the metal electrode 1 into the regeneration cell 4.

FIG. 1D shows the regeneration cell 4 in the process of the regeneration of the metal electrode 1, which has been transferred into said regeneration cell 4. A power supply that provides electricity for regeneration is not shown in FIG. 4.

FIGS. 2A-2B show cross-sectional views of a cylindrical regeneration cell for the recovery of the multiple metal electrodes.

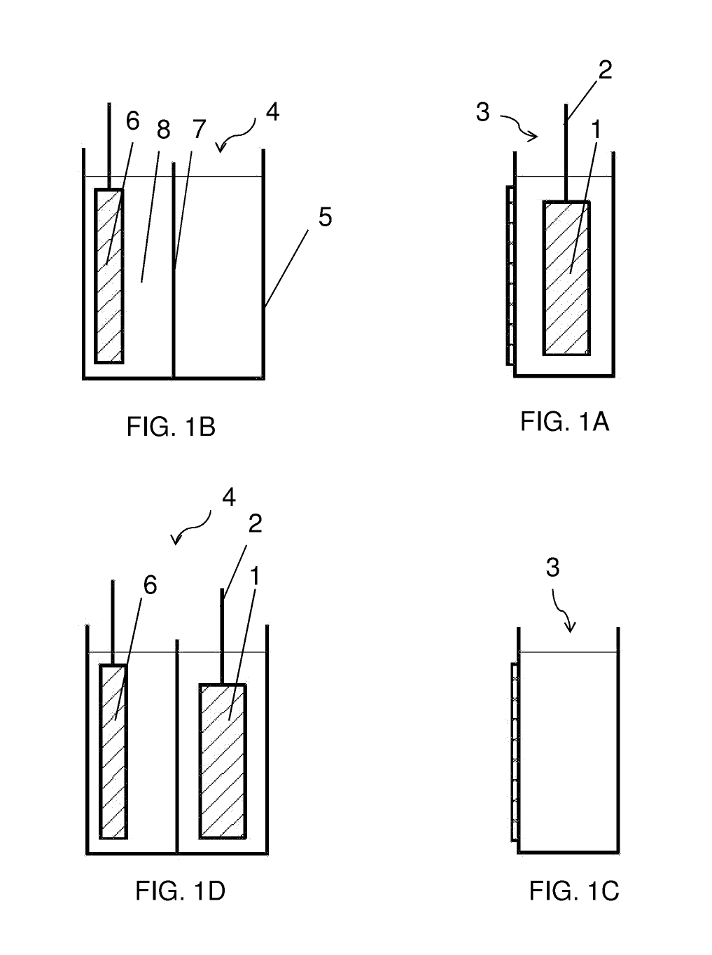

FIG. 1A shows the sectional view of the cylindrical regeneration cell suitable for reduction of the multiple metal electrodes 1.

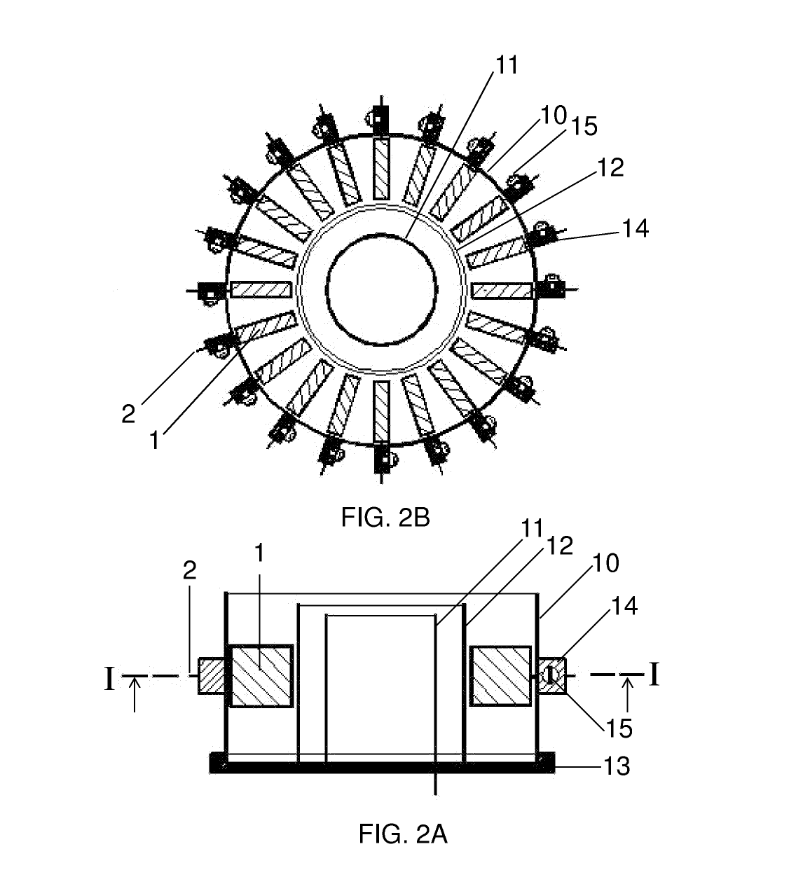

FIG. 2B shows the sectional view I-I of the regeneration cell with multiple metal electrodes 1.

### DETAILED DESCRIPTION OF THE INVENTION

The expression “metal electrode” means the metal electrode in any of its oxidation states. A replaceable metal electrode is the metal electrode of any battery that can be replaced with a similar metal electrode without breakdown of said battery. The metal electrode of this invention can also include electrolytes, adhesives, electronic conductors, inhibitors and other additives usually used to produce battery electrodes. The regeneration can be carried out using direct, pulsating or alternating current if required.

Metal-air batteries can use aluminum, magnesium, zinc, iron, silicon, lithium and their alloys as the anodes. Unlike other metals, zinc and iron electrodes are suitable for electrochemical regeneration in the aqueous electrolytes. The application of non-aqueous solvents and molten salts as the medium for regeneration extends the list of the metal electrodes suitable for electrochemical reduction. For example, when a lithium electrode is designed as the replaceable electrode, the lithium electrode can be regenerated in the non-aqueous electrolytes.

When the oxidized metal electrode is electrochemically reduced inside a rechargeable metal-air battery, the conjugated reaction at the counter electrode is water oxidation to oxygen. This reaction has high overvoltage, and the regeneration efficiency might not exceed 80%. The use of the replaceable metal electrode provides a unique opportunity of the metal electrode regeneration in the supplementary electrochemical cell with a counter electrode reaction more suitable than water oxidation from the energetic point of view.

Another advantage of the regeneration system of this invention is the formation of a commercial product as the result of the chemical agent oxidation on the counter electrode. The cost of regeneration will include two components: the cost of electrochemical reduction (the consumed electricity, labour etc), and the cost of the product formed. The cost of the metal electrode regeneration will be estimated as the difference between the costs of the electrochemical reduction and the goods produces. As the result the cost of regeneration can be dramatically decreased.

FIG. 1A-FIG. 1D demonstrate the regeneration of the metal electrode 1 with the current collector 2 of the metal-air battery 3 in the regeneration cell 4. The cell 4 comprises of the body 5, the counter electrode 6, the separator 7, and the solvent 8 that includes the dissolved electrolyte and the chemical agent. FIG. 1A and FIG. 1B show the metal-air battery 3 and the regeneration cell 4 before the transfer of the replaceable metal electrode into the regeneration cell; FIG. 1C and FIG. 1D show the metal-air battery 3 and the regeneration cell 4 after the transfer of the metal electrode 1 intended for reduction.

The process of regeneration comprises of following steps: a) the metal electrode 1 is pooled out of the metal-air battery 3, b) the metal electrode is transferred into the regeneration electrochemical cell 4 (FIG. 1D); c) the negative output of the power supply is applied to the metal electrode 1 and positive output to the counter electrode 6 until the metal electrode is reduced to metal; d) the metal electrode is transformed back to the metal-air battery 3 or moved into a container with alkaline electrolyte to store for further use. This container is not shown in FIG. 1A-FIG. 1D.

The design of the regeneration cell is not limited to the basic design presented in FIG. 1A-FIG. 1D, and can include multiple set of the replaceable zinc electrodes. The cross-section of the cylindrical regeneration cell with multiple metal electrodes 1 is shown in FIG. 2A. The regeneration cell in FIG. 2A includes cathode 10, counter electrode 11, and optional ion-selective membrane 12, which are mounted on the non-conducting base 13. A plurality of metal electrodes 1 is connected to the cathode 10 by fixing the current collector 2 of each electrode to the holders 14 with screws 15. The cathode 10 can be moved vertically to connect metal electrodes. The horizontal cross-sectional view (I-I) is shown in FIG. 2B.

The regeneration cell can be cooled or warmed, can be a stationary or a flow electrochemical cell. The plane counter electrode 6 (FIG. 1B) or cylindrical counter electrode 11 (FIG. 2A) are made of noble metal, silver or its alloy, nickel or its alloy, stainless steel, titanium or its alloy, niobium or its alloy, tantalum or its alloy, copper or its alloy, lead or its alloy, indium or its alloy, tin or its alloy, doped titanium dioxide, lead dioxide, doped tin dioxide, doped indium oxide, graphite, graphite composite, or boron-doped diamond electrode. The surface of the counter electrode can be covered with a suitable catalyst.

The chemical agent can be dissolved in the solvent together with electrolyte, or can be mounted on the counter electrode as a paste or a pressed pellet. The counter electrode can be formed of continuous metal, metal mesh, expanded metal, or metal foam. The product of oxidation of said chemical agent can be in liquid, solid or gaseous form. When the product of the oxidation of the chemical agent is gas, the regeneration cell can include a gas diffusion counter electrode.

One of the possible agent for oxidation in the regeneration cell is ammonium sulfate that can be oxidized on the counter electrode to ammonium persulfate. Thiocyanate can be used as a catalyst. The regeneration cell includes the ion exchange membrane as a separator. Sodium sulfate and potassium sulfate can be used to produce sodium and potassium persulfate salts. It is possible to use many other inorganic compounds for electrochemical oxidation to peroxides.

An iodide, bromide or chloride salt can be used as the agents for oxidation on the counter electrode. The oxidation of the iodide salt will produce solid iodine or a water soluble complex of iodine with iodide. The oxidation of the chloride salt will result in the production of gaseous chlorine. The counter electrode in this case can be formed of titanium protected by a thin film of doped titanium dioxide and a noble metal catalyst.

Metal ions or metal complexes can be used as agents for oxidation on the counter electrode. For example manganese sulfate can be oxidized to manganese dioxide. Iron hydroxide can be oxidized to a ferrate (VI) salt in the alkaline solution; potassium ferrocyanide can be oxidized to potassium ferricyanide.

A conjugated organic molecule, or complex, or a polymer can be used as the chemical agent. As an example nickel phthalocyanine or platinum phthalocyanine can be oxidized to its cation-radical salts in the process of solid state oxidation. Metal phtalocyanines can be deposited on the surface of the counter electrode in form of composition with the adhesive, for example Teflon. This oxidation can be performed in the aqueous or non-aqueous solvents or mixture thereof. The example of a non-aqueous solvent is propylene carbonate. Perchlorate lithium or perchlorate zinc salts can be used as electrolytes. A conjugated polymer, for example polyaniline, can be oxidized on the counter electrode to the cation-radical salt of polyaniline.

A monomer that can be converted into a polymer by anodic polymerization can be used as the chemical agent. The examples of monomers that can be underwent anodic polymerization include, but are not limited to aniline, its complexes, salts or derivatives; pyrrole, its salts, it complexes, or its derivatives; thiophene, its salts, complexes or derivatives.

As an example aniline can be converted to polyaniline by electrochemical oxidation of aniline in the aqueous electrolytes that contain zinc chloride, sulfate, formiate, acetate or any other salt. The product of oxidation is a conducting polymer. To accelerate the process of polymerization (more accurate condensation) the electrolyte can include a dissolved catalyst selected from known catalysts, for example salts of noble metals, for aniline polymerization. As an alternative, the counter electrode can have a layer of a solid catalysts deposited on its surface as the initiator of the polymerization.

This invention is not limited to the details of the illustrative embodiments, and the present invention can be embodied in other specific forms without departing from essential attributes thereof, and it is desired that the present embodiments will be considered in all respects as illustrative and not restrictive.

1. A regeneration system for a replaceable metal electrode of a battery that includes a regeneration electrochemical cell, an electrolyte dissolved in a solvent, and a counter electrode wherein said system includes a chemical agent suitable for electrochemical oxidation with the formation of a commercial product

2. The regeneration system of claim 1 wherein the metal electrode is zinc, iron, lithium, sodium, calcium, magnesium, aluminum, or silicon

3. The regeneration system of claim 1 wherein the solvent is aqueous, non-aqueous or mixture thereof

4. The regeneration system of claim 1 when the regeneration current is direct, pulsating or alternating

5. The regeneration system of claim 1 wherein the solvent further includes a catalyst

6. The regeneration system of claim 1 wherein the electrochemical cell further includes an ion selective membrane or a separator that divides the cell into the anode and cathode compartments

7. The system of claim 1 wherein said chemical agent is a monomer that can be polymerized by electrochemical polymerization

8. The system of claim 1 wherein said chemical agent is aniline, its oligomer, its salt, its complex, or its derivative

9. The system of claim 1 wherein said chemical agent is pyrrole, or pyrrole oligomer, or pyrrole derivative, or pyrrole salt

10. The system of claim 1 wherein said chemical agent is thiophene, or oligomer of thiophene, or thiophene derivative, or thiophene salt

11. The system of claim 1 wherein said chemical agent is halogenide

12. The system of claim 1 wherein said chemical agent is a conjugated organic compound suitable for oxidation

13. The system of claim 1 wherein said chemical agent is ammonium sulfate, sodium sulfate or potassium sulfate

14. The system of claim 1 wherein said chemical agent is a metal ion or metal complex suitable for oxidation

15. The system of claim 1 wherein the counter electrode is made of materials selected from noble metals, silver or its alloy, nickel or its alloy, stainless steel, titanium or its alloy, niobium or its alloy, tantalum or its alloy, copper or its alloy, lead or its alloy, indium or its alloy, tin or its alloy, doped titanium dioxide, lead dioxide, doped tin dioxide, doped indium oxide, boron doped diamond electrode, graphite or a graphite composite

16. The system of claim 1 wherein said counter electrode is covered by a layer of a catalyst

17. The regeneration system of claim 1 wherein said counter electrode is a continues electrode, a mesh electrode, an expanded electrode, a foam electrode or a gas diffusion electrode

18. The regeneration system of claim 1 wherein the electrochemical cell includes multiple set of replaceable zinc anodes

19. The regeneration system for a replaceable zinc electrode that includes an electrochemical cell, a replaceable zinc electrode, an electrolyte, and a counter electrode wherein the counter electrode includes a solid or paste electroactive substrate suitable for electrochemical oxidation

20. The method of regeneration of the replaceable metal electrode wherein 1) the metal electrode is pooled out of the metal-air battery and transferred into the regeneration cell; 2) the negative output of a power supply is applied to said metal electrode and positive output to the counter electrode until the metal electrode is reduced to metal, 4) said metal electrode is moved back into the metal-air battery or transferred into a container with the alkaline electrolyte to keep it on hold for further use
